(19) United States
(12) Patent Application Publication
(10) Pub. No.: US 2011/0113444 A1
(43) Pub. Date: May 12, 2011

(54) Index of video objects

(76) Inventor: Dragan Popovich, Bellevue, WA (US)

(21) Appl. No.: 12/927,216

(22) Filed: Nov. 9, 2010

Related U.S. Application Data
(60) Provisional application No. 61/281,028, filed on Nov. 12, 2009.

(51) Int. Cl. H04N 5/445; H04N 7/10

(52) U.S. Cl. 725/32; 725/37

(57) ABSTRACT

A system for indexing physical objects, locations and people, collectively referred to as video objects, which appear in videos. The system enables video object-level identification of TV and video content, and makes those video objects indexable, linkable, and searchable.

### RELATED APPLICATIONS

This application claims priority to provisional application 61/281,028, filed Nov. 12, 2009.

### FIELD

The present application relates to content selection, and, more particularly, to indexing video content.

### BACKGROUND

The availability, quality, and selection of online video programming have all improved dramatically. As a result, consumers have been shifting their viewing habits from traditional TV (broadcast, cable or satellite) towards online viewing, where they can watch anything that is available on demand with far fewer commercial interruptions. This shift towards online TV and video viewing also gives rise to a possibility of a viewer interacting with the TV and video programming in ways that have not been possible with the traditional TV.

### SUMMARY

The instant application describes ways to identify objects in videos, store information about where an object is displayed in the videos, and allow the content owner or publisher (the “provider”) to give related information to a viewer of the videos. For example, if the object of interest is a car, information on where else in the videos the car may be found could be displayed or made available. In another implementation, the provider may give a list of other videos that may be of interest to a viewer based on the viewer's interest in the car. The provider may also provide links to other sources of information about the car, such as links to online reviews, links to advertisements (ads) where similar cars are for sale, or links to dealers' websites. One skilled in the art will recognize that many types of information could be linked to one or more objects identified in the video, and that zero or more links could be associated with any such objects.

### BRIEF DESCRIPTION OF THE OF THE DRAWINGS

These and other features and advantages of indexing video content will now be described with reference to drawings of certain embodiments, which are intended to illustrate and not to limit the instant application:

FIG. 1 is an example of a system in which an index of video objects may be implemented;

FIG. 2 is a system diagram of an example of a technology platform in which an index of video objects may be implemented;

FIG. 3 shows a system diagram of an example of the technology platform and a client;

FIG. 4 shows an example of a process of analyzing a video file frame by frame;

FIG. 5 shows an example of the identification of video objects in a frame;

FIG. 6 shows another example of the identification of video objects in a frame;

FIG. 7 shows an example of a table associating an object in a video frame with an object type and characteristic;

FIG. 8 shows one possible implementation of a table listing frame n with all video objects identified and recorded, and all relevant characteristics of each video object recorded and described;

FIG. 9 shows one possible implementation of a table listing video objects O1-Om and their descriptive characteristics C1-Cn;

FIG. 10 shows one possible implementation of a table listing all scenes S1-Sm and their descriptive characteristics C1-Cn;

FIG. 11 shows one possible implementation of a table listing a hierarchy of all episodes/movies, chapters, scenes, shots and frames.

FIG. 12 shows one possible implementation of a Frame/Object Reference Table for a video consisting of Fn frames and with Om distinct objects appearing in the video.

FIG. 13 illustrates a component diagram of a computing device according to one embodiment.

### DETAILED DESCRIPTION

The instant application describes ways to identify objects in videos, store information about where an object is displayed in the videos, and allow the content owner or publisher (the “provider”) to give related information to viewers of the videos. For example, if the object of interest is a car, information on where else in the videos the car may be found could be displayed or made available. In another implementation, the provider may give a list of other videos that may be of interest to a viewer based on the viewer's interest in the car. The provider may also provide links to other sources of information about the car, such as links to online reviews, links to advertisements where similar cars are for sale, or links to dealers' websites. One skilled in the art will recognize that many types of information could be linked to one or more objects identified in the video, and that zero or more links could be associated with any such objects. A link means anything that may be selected by a user and may cause an action to occur when selected. For example, a link to a web page may cause a web page to be displayed.

A video may contain individual frames, shots (a series of frames that runs for an uninterrupted period of time), scenes (a series of shots filmed at a single location), chapters or sequences (a series of scenes that forms a distinct narrative unit), or episodes or movies (a series of chapters/sequences telling the whole story).

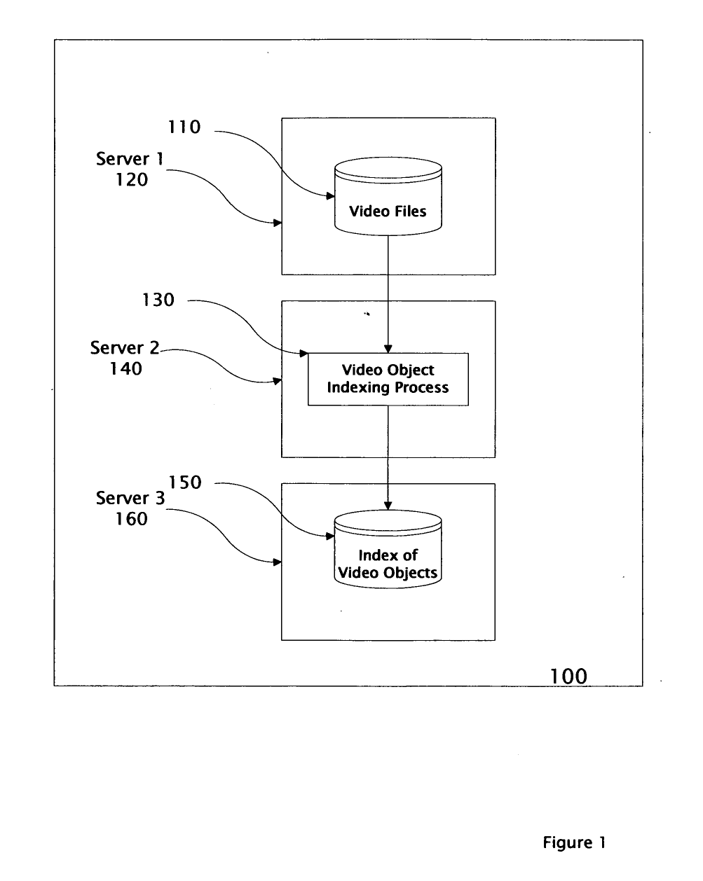

FIG. 1 shows an example of a system (100) for indexing physical objects, locations and people of interest (collectively referred to as video objects) that appear in videos. The system (100) will enable video object-level identification of video content, and will make those video objects indexable, linkable, and searchable.

In order to create an index of the video objects in a video, one or more of video files 110, stored on Server 1 (120) may be analyzed using an appropriate Video Object Indexing Process (130). This process can be either automatic, i.e. by means of video and image analysis software program (in this example, such software is running on Server 2 (140) that can recognize various video objects in a video file and track their location and movement over time, or manual, i.e. by using human operators that would perform the same task of recognizing and tracking various video objects in the video file, or some combination of automatic and manual video analysis methods. The system (100) allows the indexing of a large number of video objects.

As shown in the example in FIG. 1, the video object indexing process (130) creates an index of video objects (150) of interest for each of the video files (110) processed. If each of the video files (110) represents an episode of a show or a movie, then the index of video objects (150) grows as additional episodes of the same show are added. Both the existing episodes of each show and the newly created episodes may be indexed. Once the complete show or a desired portion is indexed, other shows may be indexed, which may be on the same channel, or on different channels, or on different networks. With movies, each movie from a studio may be indexed, to include both existing movies and newly created movies. Once the complete movie or a desired portion is indexed, other movies may be indexed, which may be from the same studio or from different studios.

The index of video objects (150) could potentially comprise all or nearly all video objects, at the discretion of providers. The index of video objects (150) can comprise professionally created video content, amateur (user generated) content, or a combination of these or any other types of video.

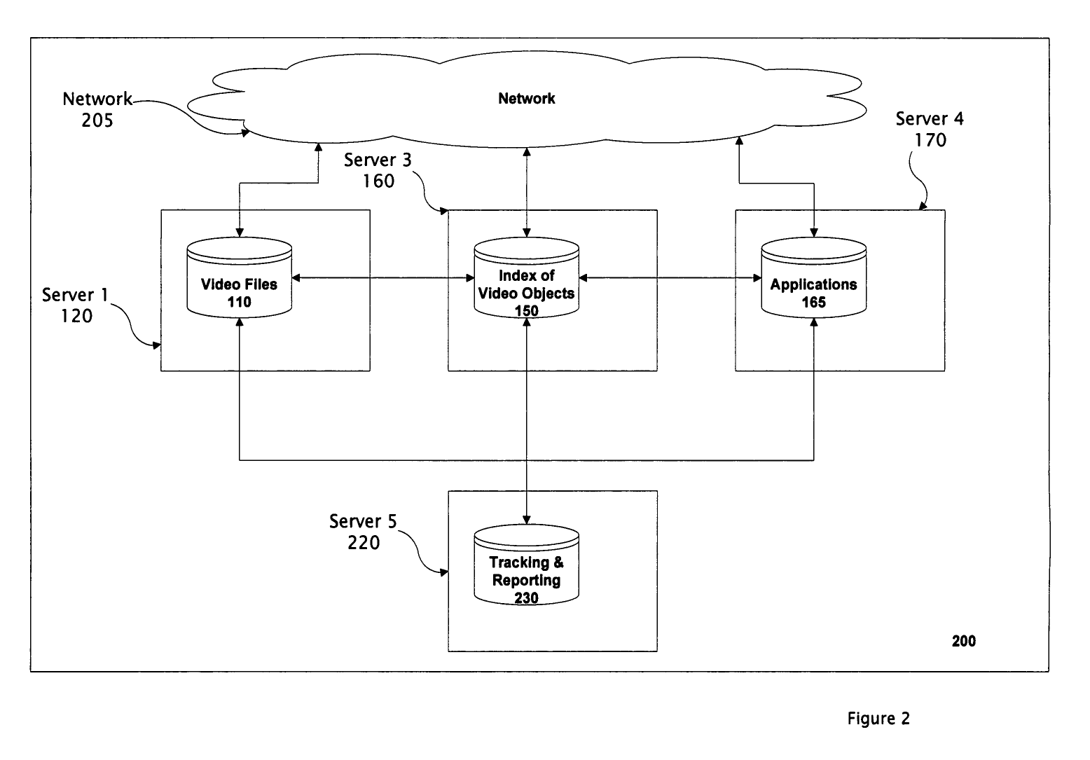

FIG. 2 is a system diagram of an example of a technology platform capable of supporting an index of video objects. As shown in the example in FIG. 2, a technology platform (200) may include the video files (110), the index of video objects (150), applications (165), and tracking and reporting functionality (230). The index of video objects (150) and an associated globally unique identifier (GUID), a universally unique identifier (UUID), or any other identifier for each video object and each episode may allow any video object to be linked to any other video object, episode, or any other target link desired, such as a location on the internet. One skilled in the art will recognize that there are many different ways video objects or episodes could be identified. As the index of video objects (150) grows in a linear fashion by adding more episodes and channels, the number of possible links or connections between video objects will grow exponentially. This exponential growth of links between video objects will also represent the exponential growth in a viewers' choice with regards to their entertainment options.

There are many possible ways for a TV network, a movie studio, or another content creator or provider to employ the index of video objects (150) to make their video programming more attractive to the viewer. In this context, making video programming more attractive to the viewer may include offering one of the applications (165), which will make the viewer more engaged with the video content and spend more time interacting with the video content, as well as interacting in ways that are novel and not enabled by the current technology. A content creator or provider may also wish to add the tracking and reporting functionality (230), which would tell them how the index of video objects (150) and the applications (165) are being used by the viewers.

In this example, the video files (110) are stored on Server 1 (120), the index of video objects (150) are stored on Server 3 (160), the Applications (165) are stored on Server 4 (170), and the Tracking and Reporting (230) functionality is performed on Server 5 (220). These various servers are communicatively connected by a Network (205). Any one or more of these servers may be implemented on one or more physical computers. As one skilled in the art will recognize, different implementations may comprise differing numbers of physical computers or other equipment, and the communications connections may be implemented in many different ways, including but not limited to local area networks, wide area networks, internet connections, Bluetooth, or USB wiring.

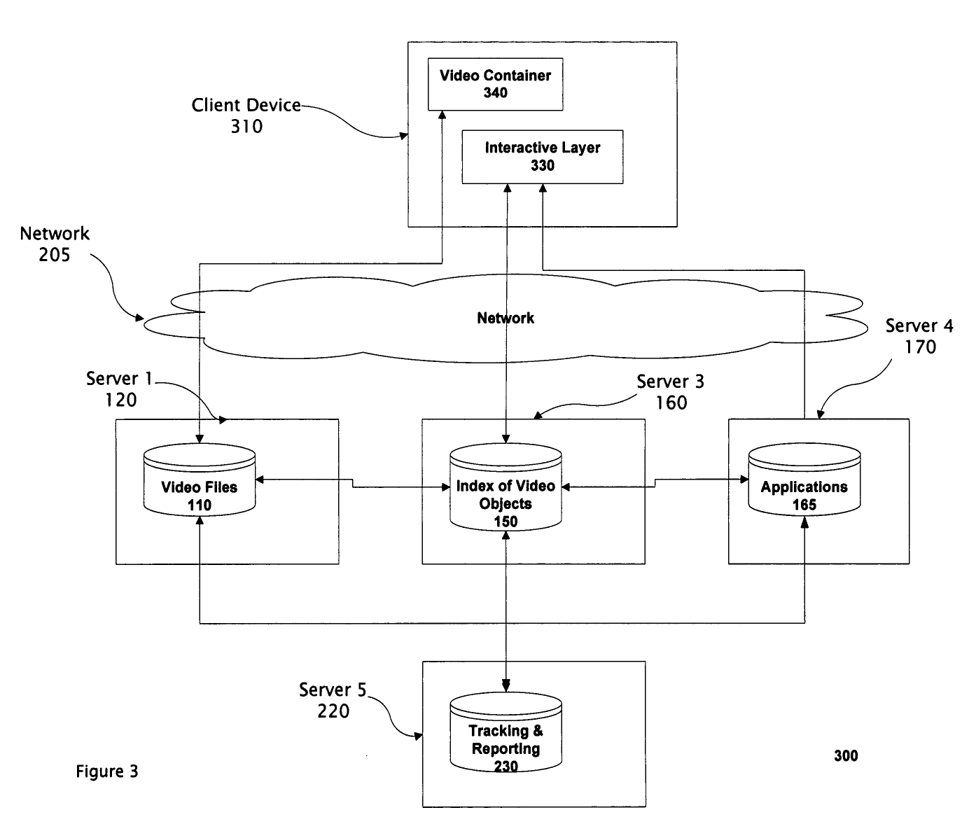

As shown in the example in FIG. 3, the technology platform (200) may be linked to a client device (310), which may be a user's local PC, which includes one or more input devices, one or more output devices, and a CPU, and while operating as a video presentation system includes a video container (340) in communication with the video files (110), and an interactive layer (330) in communication with the index of video objects (150) and the applications (165).

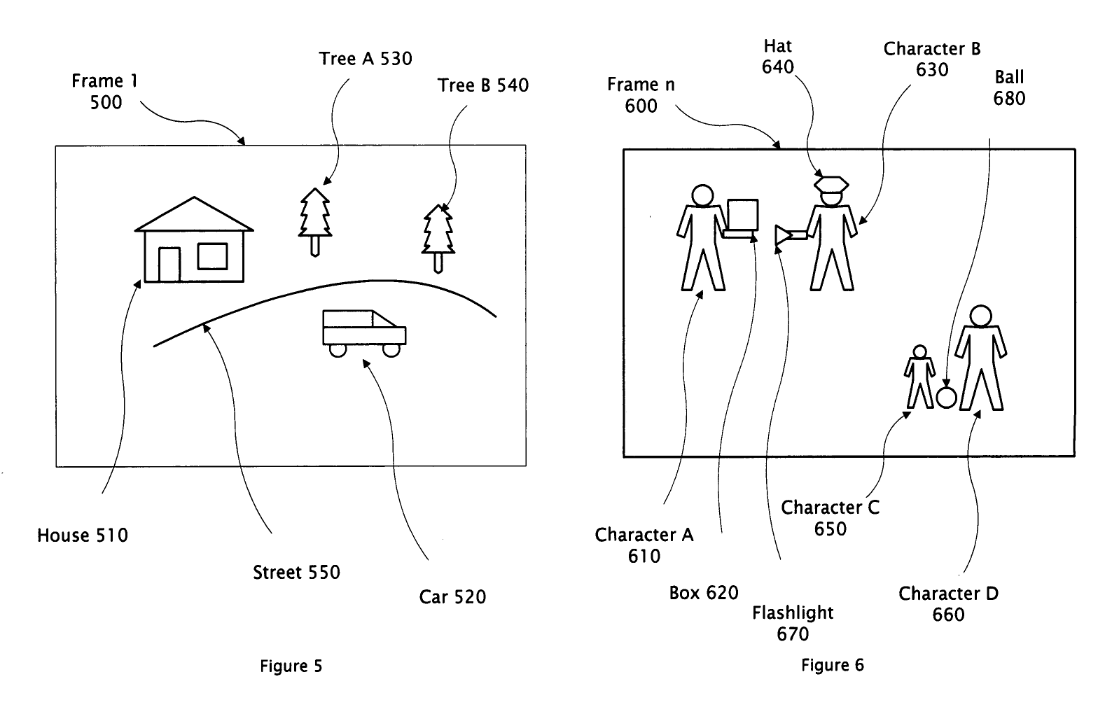

For video, the technology platform (200), may provide one or more video files (110) that have been partly or fully indexed, may provide the index of video objects (150) for the video file, may provide the interactive software applications (165) related to video objects, and may provide the interactive layer (330) on the client (310) for the video file. The interactive layer (330) may allow objects in the video to be selected, for example by a viewer clicking, which may invoke the information stored in the index of video objects (150) and may allow the viewer to start any of the applications (165) associated with that object. The technology platform (200) may also include the tracking and reporting mechanism (230) that will collect information on which objects (see FIGS. 5 and 6) in a given video are being clicked, which information from the index of video objects (150) is being invoked, which applications (165) are being started, and which viewers are performing these actions.

In another implementation, the technology platform (200) may also be used for traditional TV video by providing the video files (110) that have been partly or fully indexed, providing the index of video objects (150) for the video file, providing the interactive software applications (165) related to video objects, and providing a TV-enabled interactive layer (330) for the video files (110). The interactive layer (330) may allow objects in video to be selected by the viewer, invoking the information stored in the index of video objects (150) and may allow the viewer to start one or more of the applications (165) associated with that object, and providing a tracking and reporting functionality (230) that will collect information on which objects in a given video are being selected, which information from the index of video objects is being invoked, which applications (165) are being started, and which viewers are performing these actions.

The technology platform (200) may also be implemented for video on video-game consoles, by providing the video files (110) that have been partly or fully indexed, providing the index of video objects (150) for the video file, providing the interactive software applications (165) related to video objects, and providing a video game console-enabled interactive layer (330) for the video files (110). The interactive layer (330) may allow objects in video to be selected by the viewer, which may invoke the information stored in the index of video objects (150) and may allow the viewer to start one or more of the applications (165) associated with that object, and may provide a tracking and reporting functionality (230) that may collect information on which objects in a given video are being selected, which information from the index of video objects (150) is being invoked, which applications (165) are being started, or which viewers are performing these actions.

The technology platform (200) may also be implemented for mobile device video (i.e. video on mobile devices such as smart phones, pocket computers, Internet-connected portable video game players, Internet-connected music and video players, tablets and other analogous devices) by providing the video files (110) that have been indexed, providing the index of video objects (150) for the video file, providing the interactive software applications (165) related to video objects, and providing a mobile device-enabled interactive layer (330) for the video files (110). The interactive layer (330) may allow objects in video to be selected by the viewer, which may invoke the information stored in the index of video objects (150) and may allow the viewer to start one or more of the applications (165) associated with that object, and may provide a tracking and reporting functionality (230) that may collect information on which objects in a given video are being selected, which information from the index of video objects (150) is being invoked, which applications (165) are being started, or which viewers are performing these actions.

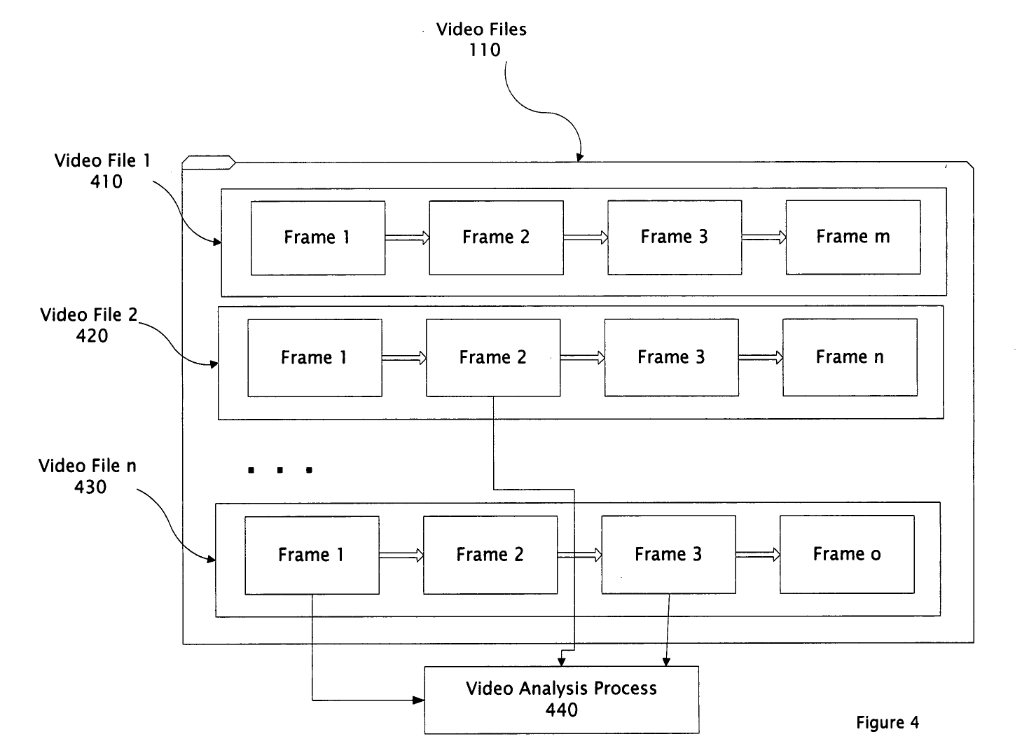

FIG. 4 shows an example of a process of analyzing a video file frame by frame. As shown in FIG. 4, an input to the video analysis process is at least one of the video files (110), which in this example include Video File 1 (410), Video File 2 (420), through to Video File n (430), with each video file (110) comprising Frames 1 through m, n, and o respectively. The video analysis process (440) analyzes one or more of the frames from the at least one of the video files (110) and creates a list of the one or more of the frames from the at least one of the video files (110).

As shown in FIGS. 5 and 6, for each frame processed by the video analysis process, at least one of the video objects House (510), Car (520), Tree (530), Tree (540), Street (550), Character A (610), Box (620), Character B (630), Hat (640), Character C (650), Character D (660), Flashlight (670), and Ball (680) are identified or recognized, and their contours, surface area, location in the video frame, relative size, or any combination of these or other characteristics are recorded. Any metadata the video files expose may be used if so desired. Metadata may include, by way of example and not limitation, any data about the video objects, such as information about location in the videos (110), characteristics of the physical object the video object represents, such as color, shape, or size, and any categories the content creator or provider may include.

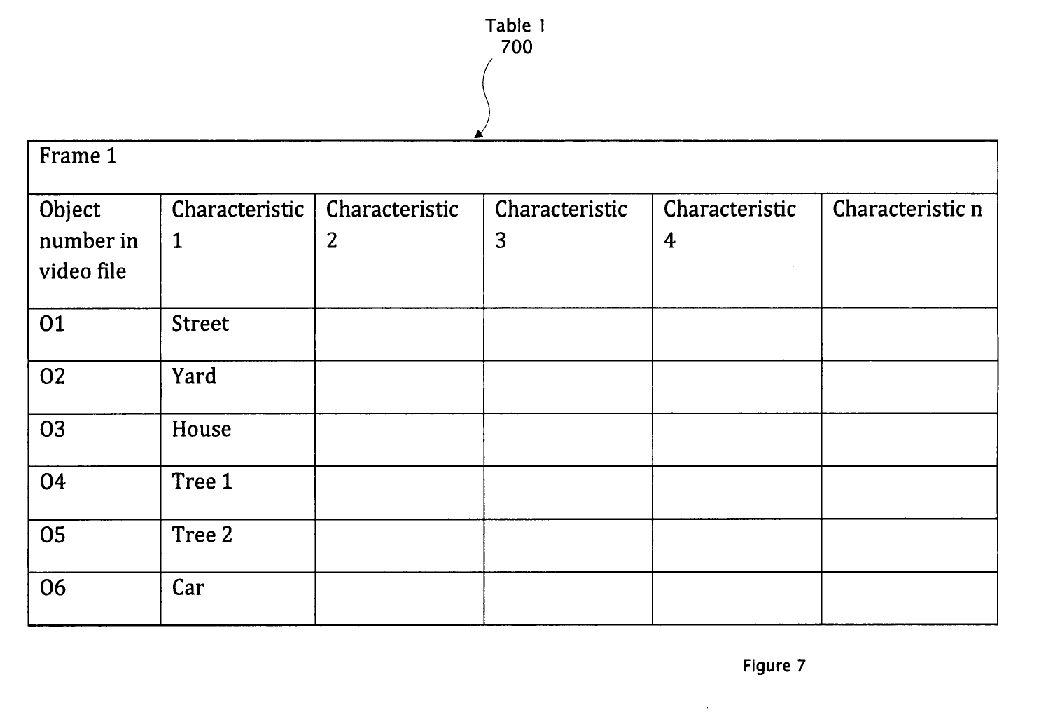

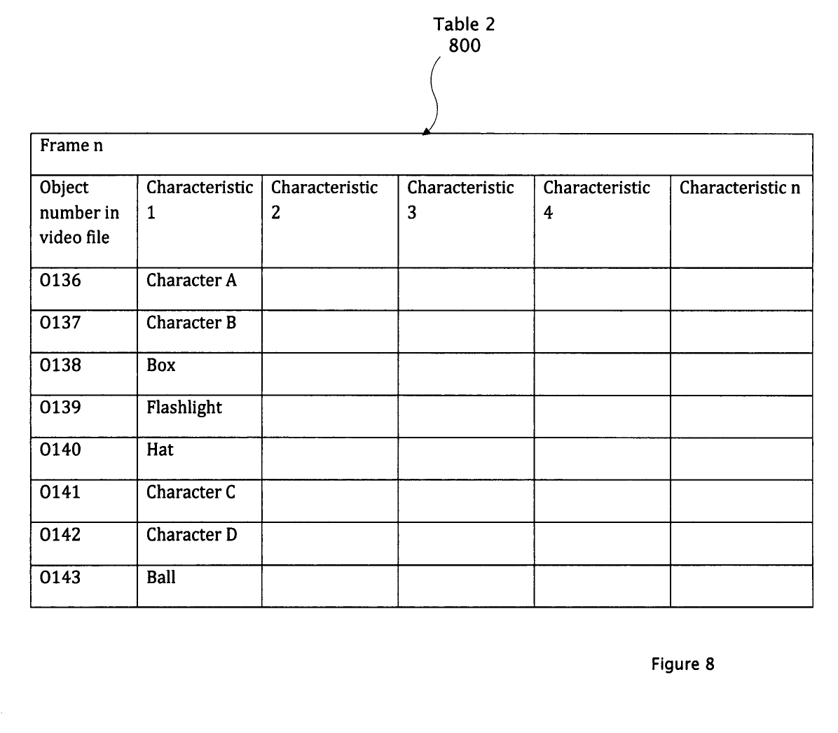

As shown as an example in FIG. 7 and FIG. 8, metadata may be recorded for each video object, such as its type (person, animal, plant, physical object such as chair, door, car, house, location such as street, beach, or any other classification desired) and other relevant metadata. FIGS. 7 and 8 show respective sample tables (Table 1 (700) and Table 2 (800), respectively) associated with Frame 1 (500) and Frame n (600) with video objects identified and recorded, and all relevant characteristics of each video object recorded and described. One or more video objects in one or more frames are enumerated. The one or more video objects and corresponding metadata constitute the index of video objects (150).

If, for example, a video object is a Character A (610), then the character's name may be recorded, or if the video is a representation of a story, then the character's name and actor's name may be recorded. Additional characteristics of a person such as physical ones, e.g. posture, stature, motion, clothing, hairstyle, as well as non-physical characteristics, such as mood or mental state may also be recorded.

If, for example, the video object is an animal, then its species (dog, cat, horse, or whatever species it is), breed if relevant (terrier, Afghan Hound, German Shepherd, or whatever breed it is), or name if relevant, may be recorded. Additional characteristics of an animal such as physical ones, for example posture, stature, motion, fur or skin color, as well as non-physical characteristics, for example mood, etc. may also be recorded.

If, for example, the video object is a plant—Tree A (530) for example, then its type (tree, grass, flower, or whatever it may be), species if relevant (oak, pine, fir, or whatever species it may be), may be recorded. Additional characteristics of a plant such as size, shape, color, season (blooming, shedding leaves), historical significance, or any other metadata of interest may also be recorded.

If, for example, the video object is a physical object such as Ball (680), then its type (chair, TV set, car, window, house, rock, ball, or whatever) may be recorded. Additional characteristics of a physical object, such as size, shape, texture, color, brand, model, vintage, historical significance or other metadata of interest may also be recorded.

If, for example, the video object is a location, then its type (indoors, outdoors, dining room, street, beach, forest, mountain) may be recorded. Additional characteristics of a location, such as geographic coordinates, elevation, weather conditions, light conditions, time of day, historical significance may be recorded.

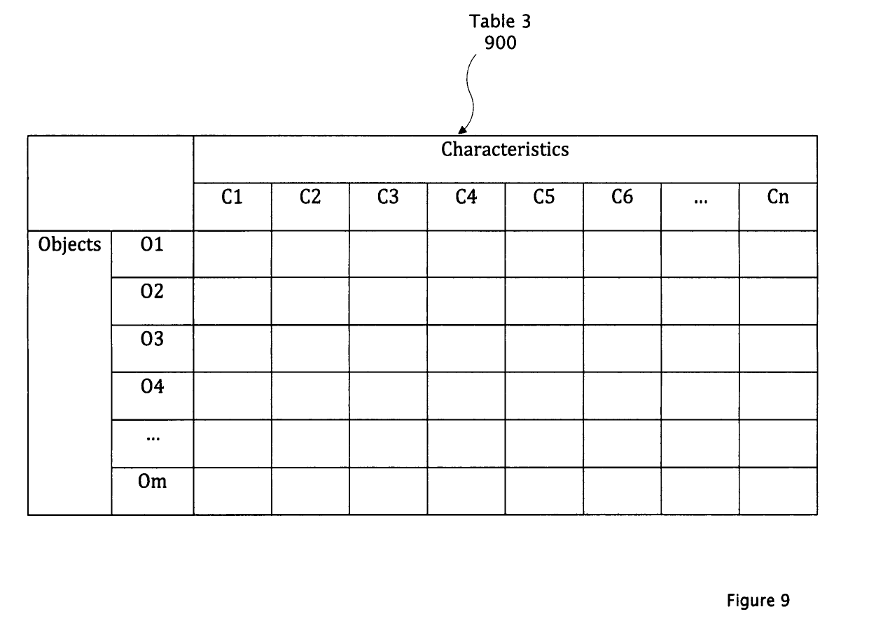

FIG. 9 shows a sample Table 3 (900) which contains a list developed by the Video Object Indexing Process (130), which includes the indexed video objects, their identification numbers, and one or more of the characteristics associated with each video object in the index. The Video Object Indexing Process (130) may consist of an object recognition software program that can analyze each frame in a video file, determine distinct individual video objects in each frame, determine the contours and locations of each distinct video object, and determine what each distinct video object is and assign characteristics to it, as discussed above.

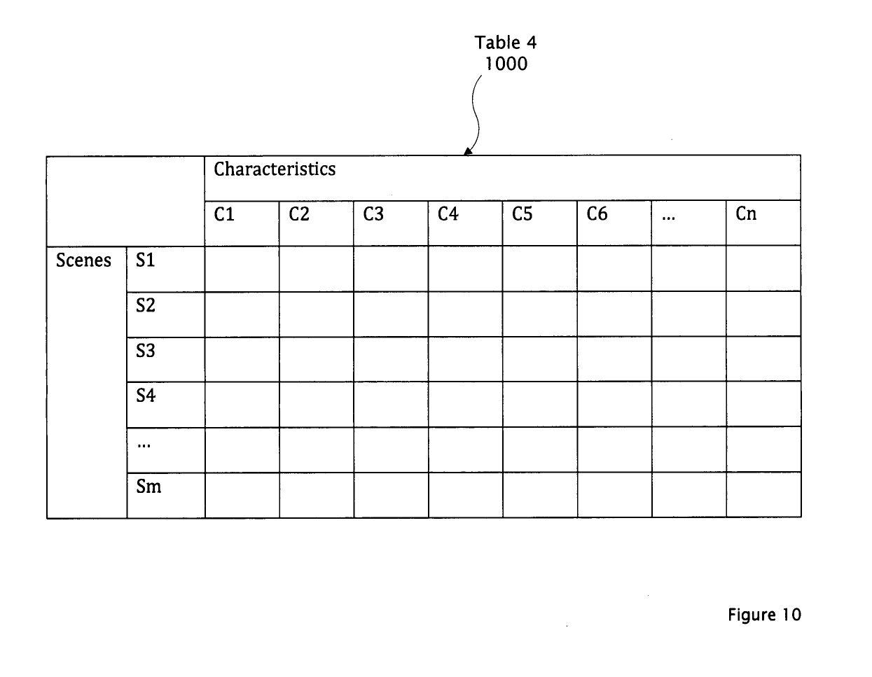

FIG. 10 shows a sample Table 4 (1000), which contains a list developed by the Video Object Indexing Process (130), which includes an aggregation of one or more scenes with their unique identification numbers, and one or more characteristics that describe each scene. However, it could also be used to aggregate frames, shots, chapters, or episodes/movies with their unique identification numbers, and all unique characteristics, that describe each frame, shot, chapter, or episode/movie.

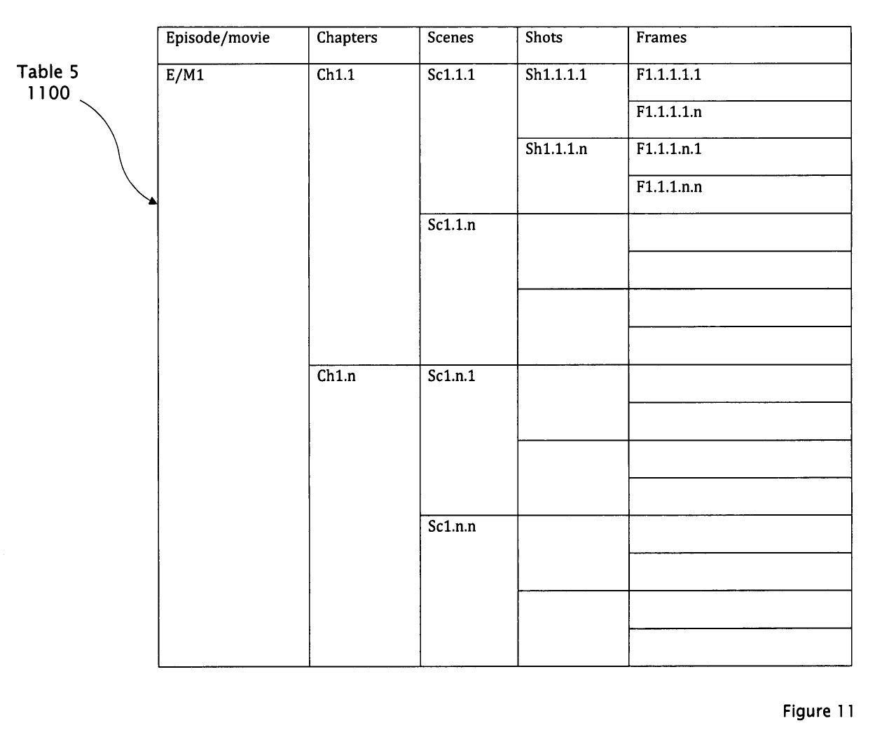

As shown in FIG. 11, the Video Object Indexing Process (130) may create Table 5 (1100), a hierarchical list that contains, for each indexed episode/movie, a list of indexed chapters in that episode/movie, a list of indexed scenes in each chapter, a list of indexed shots in each scene, and a list of indexed frames in each shot. In an alternate implementation, one or more subsets of chapters in that episode/movie, scenes in chapters, shots in scenes, and frames in shots may be listed.

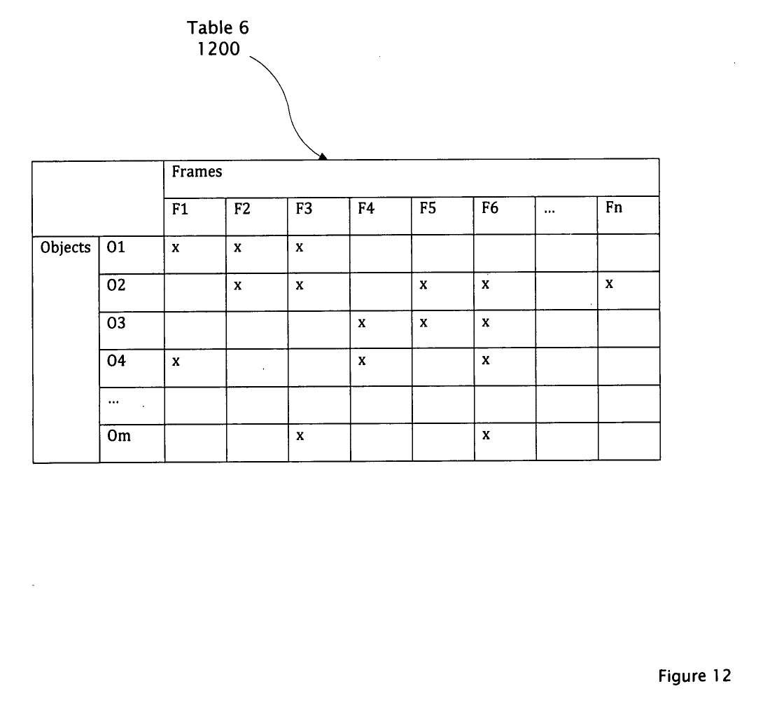

FIG. 12 shows an example of a reference Table 6 (1200) containing a list of frames in the video, and a list of individual video objects appearing in that video. The entries in the table denote which distinct video objects appear in which individual frame. The sign “x” denotes that a particular object is present in a given frame. In an alternate implementation, one or more subsets of frames in the video and individual video objects appearing in the video may be listed.

For each frame/object pair within a particular video file, a location of each video object in a given frame, for example its x-y coordinates or another description of location, and the relative size of the object, e.g. percentage of frame that the object occupies, may be recorded.

For each of the video files (110), statistical analysis may be performed on a set of frame/object pairs from that file. Individual frames may be used as the unit of measure of the duration of each video file, for example a video file may contain sixty distinct frames per second.

For each distinct object O1 to Om, a frequency of occurrence of that object in the video file may be measured and recorded: for example if a video object appears in 8% of the duration of the video file, or in other words, the video object appears in 8% of all the frames in that video file. This provides a highly useful metric for determining advertising value for a particular video object.

Referring to FIG. 12, for each distinct video object O1 to Om, an absolute length of appearance in the video file may be measured and stored, for example if the particular video object appears for a total of 3.5 minutes in a video file lasting 20 minutes. Again this provides a useful tool for advertisers to measure the viewing time of a particular object.

For each distinct video object O1 to Om, additional criteria may be applied to measures of frequency of occurrence and absolute length of appearance in a video file, such as relative size of the object (e.g. only count the object if its relative size in a video frame is above some specified threshold), location within the frame (e.g. only count the object if it appears within some specified distance from the center of the frame), continuity of appearance of the object in a series of video frames (e.g. only count the object if it appears for N number of seconds or X number of frames without interruption), and other similar criteria. These additional measures provide further highly useful metric for determining advertising value for a particular object.

As discussed above, for each distinct video object in each frame, a globally unique identifier (GUID), a universally unique identifier (UUID) or other identifier may be created. The identifier may also be created for each frame that contains all the individual video objects, shot (a series of frames that runs for an uninterrupted period of time), scene (a series of shots filmed at a single location), chapter or sequence (a series of scenes that forms a distinct narrative unit), or episode or movie (a series of chapters/sequences telling the whole story).

Links which may allow users to navigate or browse between various video objects, or between various video objects and frames, shots, scenes, chapters, and episodes/movies, or between various video objects and other locations on the Internet may be created based on the objects' identifiers. These links may be persistent, staying the same even when the video file is copied to a different location, or they can vary, for example changing when the video file is copied to a different location. The link persistency may be at the discretion of the owner or provider of the video file to match different business purposes of each owner or provider.

Each distinct video object in any given frame may be linked to one or more other video objects in any other frame, shot, scene, chapter, or episode/movie. This linking may be done within the same episode/movie, or among different episodes/movies. Also, each distinct video object in any given frame may be linked to any other frame, shot, scene, chapter, or episode/movie. This linking may be done within the same episode/movie, or among different episodes/movies.

Each distinct video object in any given frame may be linked to locations on the Internet, such as text, picture, page, video, advertising, game, or other locations. Also, each frame, shot, scene, chapter, or episode/movie can be linked to any other video object in any other frame, shot, scene, chapter, or episode/movie. This linking can be done within the same episode/movie, or among different episodes/movies.

Each frame, shot, scene, chapter, or episode/movie may be linked to any other frame, shot, scene, chapter, or episode/movie. This linking may be done within the same episode/movie, or among different episodes/movies. Also, each frame, shot, scene, chapter, or episode/movie may be linked to other locations on the Internet, such as text, picture, web page, video, advertising, game, or other locations.

When selecting a particular video object, a menu displaying multiple link options to different video objects, locations, or applications (165), as discussed above, may be shown. This menu of options may be in the form of links, or in form of tabs where each tab represents a different category of applications, where different categories can be information about an object, an Internet search, a Wiki page, advertising, a social networking page, online stores, games, or other possible categories of applications as explained below. Other formats may also be used for the menu.

Further, each distinct video object and its respective metadata (a list of descriptive characteristics) and each frame, shot, scene, chapter, or episode/movie and their respective metadata (a list of descriptive characteristics) may be exposed to search engines, including, for example, those operating on the Internet and on intranets, so that they may become discoverable not just by watching the videos but by performing a text search on any particular characteristic or metadata.

The technology platform (200) may also support a “what is” function, where a user may select a video object to obtain more information about it. For example, a user may select a car, and find that it is a 1968 Ford Mustang. This information may be provided by the content creator or provider, by advertisers, or by any other source. The platform may also support further research by the user, for example by providing a link to dealers for used Mustangs, local auto clubs supporting 1968 Mustangs, parts suppliers, or other links.

The technology platform (200) may be used to make video programming interactive and therefore more attractive to the viewers through the use of the index of video objects (150) and the associated video object identifiers. The technology platform (200) may enable viewers to explore background information (such as performing an Internet search, viewing a Wiki entry, creating a Wiki entry, viewing information stored in any other online database, or other ways of exploring background information) about any video object in a video program by clicking on the object in the video. Further, the technology platform (200) may enable viewers to go from an appearance of a video object in a video to any other appearance of that same or a similar video object in the same video, or in a different video, or anywhere on the Internet, by selecting the video object in the video. This may allow a viewer to search for more information based on an image rather than using text, so that a viewer may find information related to a car displayed in a video without even knowing what kind of car it is, for example.

The technology platform (200) may also enable viewers to switch from watching a particular episode or a movie where a particular video object appears, to watching a different episode or a movie, on the same or different channel, where the same or a similar video object appears, by clicking on the video object in the video. Further, the technology platform (200) may enable viewers to create, and participate in, online communities or social networks based on the shared interest in a particular video object appearing in a video program, by selecting the object in the video.

In one embodiment, TV networks and movie studios, i.e. producers of premium video content, are able to earn revenue by selling targeted advertising related to online viewing of their programs. In order to be able to sell targeted advertising based on their video libraries, the producers may use the index of video objects (150).

In another embodiment, the technology platform (200) facilitates interactive advertising that is incorporated into online video. The advantages are that it is easy to measure an ad's effectiveness via Tracking and Reporting (230) when viewers select the ad, and the rates that networks can charge to advertisers may therefore be higher. This type of advertising is also potentially much more acceptable to the viewers since they can interact with the ads they are interested in, instead of having to watch any pre-roll commercial.

In one embodiment, viewers may vote on the popularity of a particular video object appearing in a video program, by selecting the video object in a video.

In another embodiment, the technology platform (200) enables viewers to participate in financial transactions (such as purchase, subscribe to, purchase a ticket to visit, place a bet on, or any other relevant financial transaction) related to a particular video object appearing in a video program, by clicking on the video object in the video. Further, the technology platform (200) may enable viewers to view targeted advertising (such as links, sponsored links, text, banner, picture, audio, video, phone, SMS, instant messaging, or any other type of advertising) about a particular video object appearing in a video program, by selecting the video object in the video.

In yet another embodiment, the technology platform (200) also enables viewers to play online games (such as single-user games, multi-user games, massively multi-user online role playing games, mobile games, etc) and offline games, related to a particular video object appearing in a video program, by clicking on the video object in the video. Further, the technology platform (200) enables viewers to receive alerts (such as email, phone, SMS, instant messaging, social network, and any other type of alert), related to a particular video object appearing in a video program, by clicking on the video object in the video. Also, the technology platform (200) enables viewers to participate in audio or video conferences, and to schedule audio or video conferences, related to a particular video object appearing in a video program, by clicking on the video object in the video.

In one embodiment, a user is watching a movie (online or on TV), and he realizes that he wants to know more about a supporting actress that just entered the scene. He pauses the movie and clicks on the figure of the supporting actress. A search window or a pane pops up and he sees different categories of information associated with that actress, for example: name, biography, photos, list of other movies in which she has appeared, a list of actors she has worked with, etc. He browses through the other movies the actress appeared in, and he realizes that there is a more interesting movie that he always wanted to see, and he didn't even know she was in it. He starts watching this other movie instead.

In another embodiment, a user is watching a movie (online or on TV), and he realizes that the lead actor is driving an antique sports car that his friend just bought two weeks ago that he hasn't even had a chance to see yet. He wants to learn more about that car. He pauses the movie and clicks on the sports car. A search window or a pane pops up and he sees different categories of information associated with that car, for example: the manufacturer, local dealer and services, auto-club dedicated to that car located in his state, suppliers of spare parts, review articles from car magazines, wiki page about the car, blogs, personal web sites of other enthusiast owners, etc. He browses through the catalog of spare parts and notice that there is a promotional discount on the windshield and he remembers that his friend told him that his car came with a cracked windshield. He emails the link to the windshield in the parts catalog to his friend, and then read an article about the car on his favorite car magazine's web site. After that he continues watching the movie right where he paused.

In another embodiment, a user is watching a basketball game, and the break just started. He clicks on his favorite offensive center. A search window or a pane pops up and he sees different categories of information associated with the offensive center, for example: name, team, statistics, most memorable moments from prior games, history, other teams he was associated with, etc. He decides to review 3 point shots that the center scored so far this season, and he clicks on that category. While watching the 3 point shots, he pauses and clicks on the shoes that the offensive center is wearing. A search window or a pane pops up and he sees information about the brand and the model, and links to various sites and stores where he can buy those shoes; he browses the shopping sites and buys a pair. He gets an alert that the game is about to re-start and goes back to watching it. During the next break he goes back to checking the offensive center's statistics and he notice that there is a special multi-player online quiz, sponsored by a major beer company, based on statistics of his best college games. The Quiz participant with the highest score this month wins a plasma TV, and next 10 best scores get tickets for the finals game. He knows his friends would like to participate, so he sends online invitations to his friends to play the quiz the following weekend.

In yet another embodiment, a user is watching her favorite home decorating show, and she really likes the new kitchen that the interior decorator built for a family. She pauses the show and clicks on the person of the interior decorator. A search window or a pane pops up and she sees different categories of information associated with that decorator, e.g. her web site, which contains her biography, photos of her designs, types of design jobs she's accepting, her contact information and her schedule. Next she clicks on the faucet she likes. A search window or a pane pops up and she sees different categories of information associated with that faucet, such as the manufacturer's web site, web sites of local hardware stores, yellow page listings for local plumbers, discount offers from local plumbers, do-it-yourself plumbing books and articles on the web, etc. She bookmarks this page and continues watching the show where she paused it. After the show is over, she goes back to the bookmarked page and gets a discount coupon to buy the faucet from a local hardware store; she also gets a discount coupon for a few local plumbers that she decide to check out later.

In still another embodiment, a user is watching her favorite detective/mystery series, but this new season is different from prior seasons as it also has an interactive episode that allows viewers' participation. She watches a brief introduction into this interactive episode and her task is to look for clues, explore the links in the video, and find answers to questions. Viewers that follow the clues correctly and find answers get to see additional footage, similar to DVD extras, that is not shown to the general audience. This additional footage contains some additional clues to the mystery. Only viewers who correctly resolve this week's mystery get to see next week's interactive episode. The level of difficulty builds up with each passing week. By the time the season is over, there is considerable buzz in the online community about the interactive episode and everyone is talking about the footage that was only seen by some. The viewers who solved the mystery correctly are invited to the studio to meet the cast, and the complete interactive episode is shown as the season finale including all the extra footage, with the lead actors acting as hosts and explaining all the clues.

In yet another embodiment, a user is watching her favorite travelogue show on TV, and it is about Montreal, the city she never had a chance to visit but always wanted to. She really likes a boutique hotel that is featured in the show. She pauses the show and clicks on the boutique hotel. A search window or a pane pops up and she sees different categories of information associated with that hotel, e.g. the hotel's web site, which allows her to explore it further and make reservations. It also provides links to travel agencies that sell vacation packages, airlines, and car rental companies. She bookmarks the hotel reservation page and continues watching the show. Next she sees the feature about the downtown street that has many restaurants and bars. She pauses and clicks on the street, and a search window or a pane pops up with the local search feature showing an aerial view of the street, allowing you to click on each restaurant, see their menus, and get discount coupons for items on their menus. She bookmarks this page as well and finishes watching the show. After the show is over, she goes back to the bookmarked pages, make hotel reservations for her next vacation, and gets discount coupons for the restaurants she liked.

In another embodiment, a user is watching a movie (online or on TV), and he realizes that he wants to know where a scene or shot is located. He pauses the movie and clicks on a landmark, building or other object for which he would like to know the location. A window or pane pops up and he sees a map that can display the location via GPS coordinates, traditional map cartography, satellite, or hybrid views. The location may be linked to an internet map engine like Bing Maps or Google Earth which may then allow the user to get directions to the location he was interested from the movie.

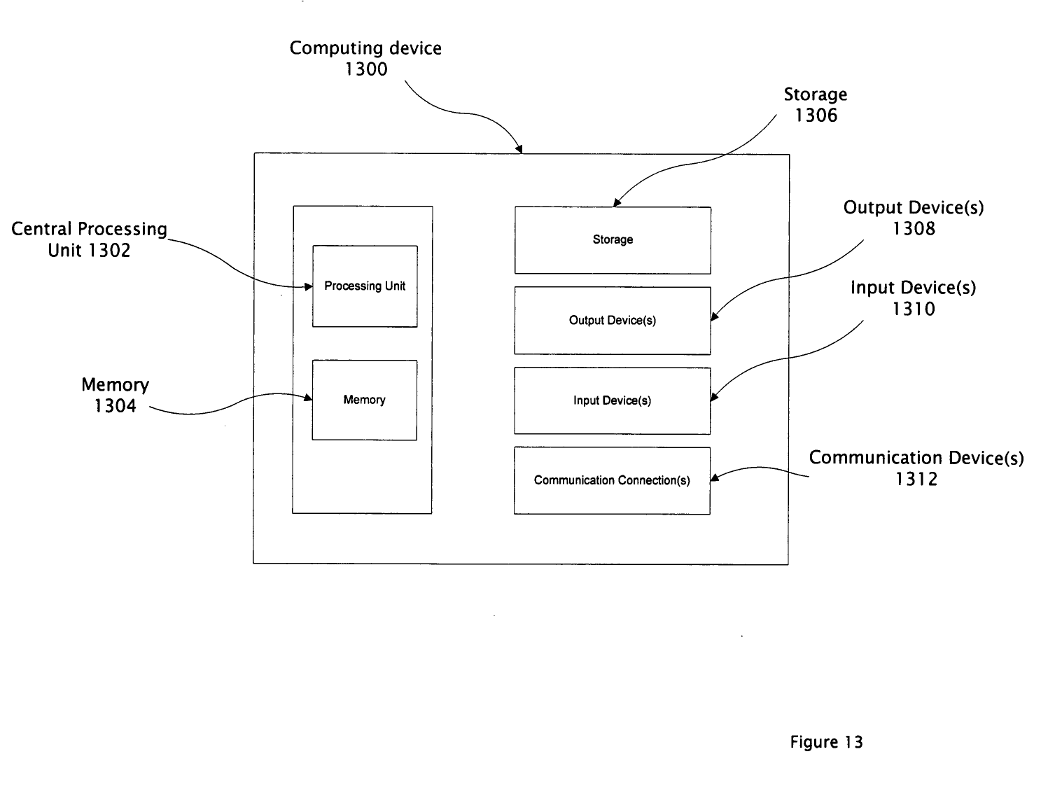

FIG. 13 illustrates a component diagram of a computing device according to one embodiment. The computing device (1300) can be utilized to implement one or more computing devices, computer processes, or software modules described herein. In one example, the computing device (1300) can be utilized to process calculations, execute instructions, receive and transmit digital signals. In another example, the computing device (1300) can be utilized to process calculations, execute instructions, receive and transmit digital signals, receive and transmit search queries, and hypertext, compile computer code as required by a Server (120, 140, 160, 170, 220) or a Client (310). The computing device (1300) can be any general or special purpose computer now known or to become known capable of performing the steps and/or performing the functions described herein, either in software, hardware, firmware, or a combination thereof.

In its most basic configuration, computing device (1300) typically includes at least one central processing unit (CPU) (1302) and memory (1304). Depending on the exact configuration and type of computing device, memory (1304) may be volatile (such as RAM), non-volatile (such as ROM, flash memory, etc.) or some combination of the two. Additionally, computing device (1300) may also have additional features/functionality. For example, computing device (1300) may include multiple CPU's. The described methods may be executed in any manner by any processing unit in computing device (1300). For example, the described process may be executed by both multiple CPU's in parallel.

Computing device (1300) may also include additional storage (removable and/or non-removable) including, but not limited to, magnetic or optical disks or tape. Such additional storage is illustrated in FIG. 13 by storage (1306). Computer storage media includes volatile and nonvolatile, removable and non-removable media implemented in any method or technology for storage of information such as computer readable instructions, data structures, program modules or other data. Memory (1304) and storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing device (1300) may also contain communications device(s) (1312) that allow the device to communicate with other devices. Communications device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device (1300) may also have input device(s) (1310) such as keyboard, mouse, pen, voice input device, touch input device, etc. Output device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

What is claimed is:

1. A system comprising:
a video indexing component configured to receive data and metadata corresponding to a video object, and store the data, metadata and an identifier corresponding to the video object;
a link management component configured to manage a link associated with the identifier; and
a link processing component configured to process the link associated with the identifier.

2. The system of claim 1 wherein the link associated with the identifier is a link to a web page.

3. The system of claim 1 wherein the link associated with the identifier is a link to information about the video object.

4. The system of claim 1 wherein the link associated with the identifier is a link to one or more frames in a video.

5. The system of claim 1 wherein the link associated with the identifier is a link to location information about a physical object corresponding to the video object.

6. The system of claim 1 wherein the link associated with the identifier provides a menu offering one or more options, each option having a link associated with it.

7. A method comprising:
receiving data and metadata related to at least one video object in at least one video frame;
storing the received data and metadata; and
associating the at least one video object with at least one link:

8. The method of claim 8 wherein the link associated with the identifier is a link to a web page.

9. The method of claim 8 wherein the link associated with the identifier is a link to an advertisement.

10. The method of claim 8 wherein the link associated with the identifier is a link to information about the video object.

11. The method of claim 8 wherein the link associated with the identifier is a link to one or more frames in a video.

12. The method of claim 8 wherein the link associated with the identifier is a link to location information about a physical object corresponding to the video object.

13. The method of claim 8 wherein the link associated with the identifier provides a menu offering one or more options, each option having a link associated with it.

14. Computer storage media containing thereon computer executable instructions that, when executed, perform the method of claim 8.

15. The computer storage media of claim 15 wherein the link associated with the identifier is a link to a web page.

16. The computer storage media of claim 15 wherein the link associated with the identifier is a link to an advertisement.

17. The computer storage media of claim 15 wherein the link associated with the identifier is a link to information about the video object.

18. The computer storage media of claim 15 wherein the link associated with the identifier is a link to one or more frames in a video.

19. The computer storage media of claim 15 wherein the link associated with the identifier is a link to location information about a physical object corresponding to the video object.

20. The computer storage media of claim 15 wherein the link associated with the identifier provides a menu offering one or more options, each option having a link associated with it.
